(19) United States
(12) Patent Application Publication
(10) Pub. No.: US 2003/0059263 A1
(43) Pub. Date: Mar. 27, 2003

(54) Rotary engraving tool

(75) Inventor: Yin-Szn Chen, Kaohsiung Hsien (TW)

Correspondence Address: BACON & THOMAS, PLLC, 625 SLATERS LANE, FOURTH FLOOR, ALEXANDRIA, VA, 22314

(73) Assignee: Zen Wu Zheng Sun Tool Co. Ltd., Kaohsiung (TW)

(21) Appl. No.: 10/142,905

(22) Filed: May 13, 2002

(30) Foreign Application Priority Data
Sep. 27, 2001 (TW) 090216520

(51) Int. Cl. B23C 5/10

(52) U.S. Cl. 407/54

(57) ABSTRACT

A rotary engraving tool includes a cylindrical body having a tapered end, and a pair of opposed main flutes defined in the cylindrical body by respective chamfer faces. The chamfer faces extend to the tapered end and form two cutting edges at where they meet with the tapered end. The rotary engraving tool with two cutting edges is excellent in making fine relief and efficient in its cutting.

### BACKGROUND OF THE INVENTION

1. Field of the Invention

The present invention relates to a rotary engraving tool and, more particularly, to a rotary engraving tool which is excellent in making fine relief and efficient in its cutting.

2. Description of Related Art

An engraving machine is widely used to cut letters or patterns on dies or printing plates of copper, especially with a rotary engraving tool. As illustrated in FIGS. 9 and 10, such a rotary engraving tool (5) typically includes a cylindrical body (50) having a tapered end (52), and a flute (51) extending from the body (50) to the end (52). The flute (51) forms two edges (53) at where it meets with the tapered end (52).

As the tool (5) is being turned in a certain direction, only one of the edges (53) serves as a cutting edge which is directed towards the material to be engraved. It has been found that the tool (5) leaves coarse surfaces in a fine relief due to the fact that the single cutting edge (53) results in an unbalanced cutting force upon the end (52) of the elongated tool (5), which is then slightly curved while rotating and cutting.

Additionally, the tool (5) with the single cutting edge (53) is not efficient in its cutting. It is necessary to remove the tool (5) time to time from the engraving machine to regrind the cutting edge (53).

Therefore, it is an objective of the invention to provide a rotary engraving tool to mitigate and/or obviate the aforementioned problems.

### SUMMARY OF THE INVENTION

The object of the present invention is to provide a rotary engraving tool which is excellent in making fine relief.

Another object of the present invention is to provide a rotary engraving tool which is efficient in cutting.

Other objects, advantages and novel features of the invention will become more apparent from the following detailed description when taken in conjunction with the accompanying drawings.

### BRIEF DESCRIPTION OF THE DRAWINGS

FIG. 1 is a front view of a first embodiment of a rotary engraving tool in accordance with the present invention;

FIG. 2 is a cross-sectional view of a snick cut by the rotary engraving tool of FIG.

FIG. 3 is a front view of a second embodiment of the rotary engraving tool in accordance with the present invention;

FIG. 4 is a cross-sectional view of a snick cut by the rotary engraving tool of FIG. 3;

FIG. 5 is a front view of a third embodiment of the rotary engraving tool in accordance with the present invention;

FIG. 6 is a cross-sectional view of a snick cut by the rotary engraving tool of FIG. 5;

FIG. 7 is a front view of a fourth embodiment of the rotary engraving tool in accordance with the present invention;

FIG. 8 is a cross-sectional view of a snick cut by the rotary engraving tool of FIG. 7;

FIG. 9 is a perspective view showing a rotary engraving tool of a conventional type; and

FIG. 10 is an end view of the rotary engraving tool of FIG. 9.

### DETAILED DESCRIPTION OF THE PREFERRED EMBODIMENT

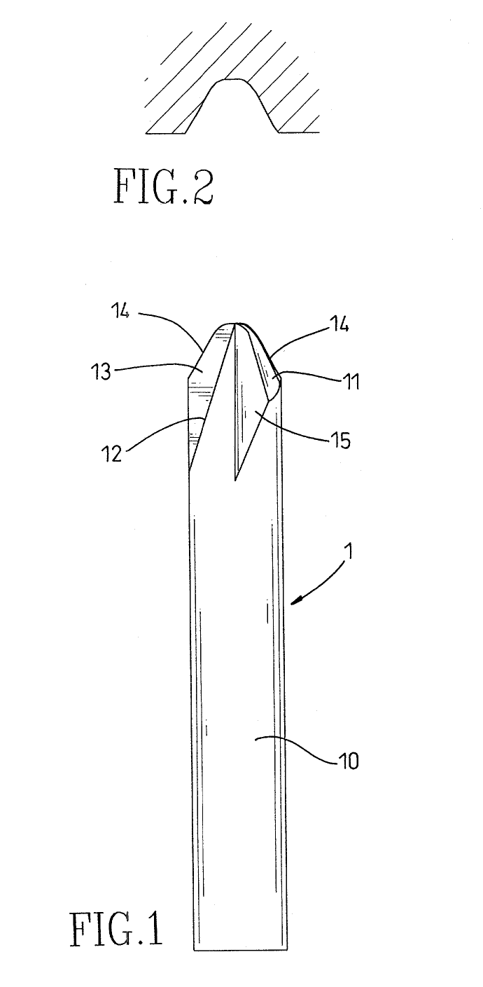

Referring to FIG. 1, there is shown a first preferred embodiment of a rotary engraving tool (1) in accordance with the present invention.

The rotary engraving tool (1) includes a cylindrical body (10) having a tapered end (11), with a pair of opposed main flutes (12) (only one is shown) extending from the body (10) to the tapered end (11). There is preferably provided a pair of opposed secondary flutes (15) extending to the tapered end (11) and arranged between the main flutes (12).

The main flutes (12) are defined, at least partially, by respective chamfer faces (13) that form two cutting edges (14) at where they meet with the tapered end (11). In addition, the cutting edges (14) are contoured to present a wide and substantially straight cutting part near an intersection thereof, and so a snick is obtained which has a cross section shaped like a trapezium with rounded inner or upper corners, as clearly shown in FIG. 2.

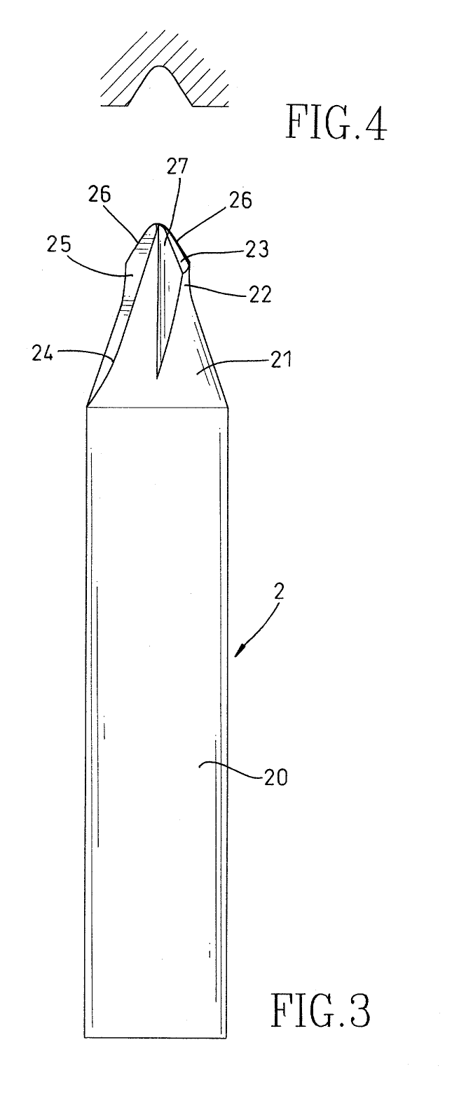

Referring to FIG. 3, there is shown a second preferred embodiment of the rotary engraving tool (2) in accordance with the present invention.

Now the engraving tool (2) includes a cylindrical body (20) having a truncated cone (21), ending in a small-diameter section (22) which is provided with a tapered end (23). The body (20) is further formed with a pair of opposed main flutes (24), as well as a pair of opposed secondary flutes (27), all extending to the tapered end (23).

The main flutes (24) are defined by respective chamfer faces (25) that form two cutting edges (26) at where they meet with the tapered end (23). In this embodiment, however, the cutting edges (26) are contoured to present a rounded cutting part at an intersection thereof.

With the rotary engraving tool (2), a snick is obtainable which has a cross section shaped like a triangle with a rounded inner or upper corner, as shown in FIG. 4.

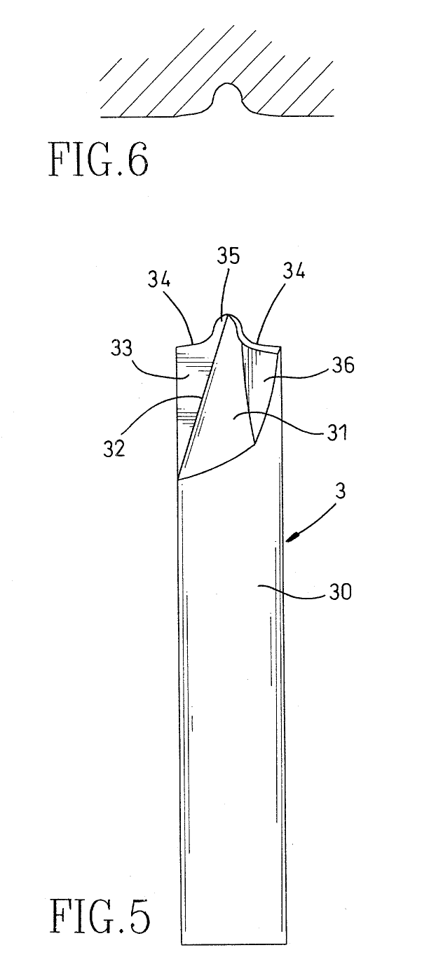

Referring to FIG. 5, there is shown a third preferred embodiment of the rotary engraving tool (3) in accordance with the present invention.

The engraving tool (3) here includes a cylindrical body (30) having a tapered end (31) terminating in a central projecting tip (35). In the engraving tool (3) there is a pair of opposed main flutes (32) and a pair of opposed secondary flutes (36) arranged alternately and extending from the body (30) up to the central projecting tip (35).

The main flutes (34) are defined by respective chamfer faces (33) that form two cutting edges (34) at where they meet with both the tapered end (31) and the projecting tip (35). The cutting edges (34) are now contoured to present a rounded cutting part in the central projecting tip (35), as well as two curved transitions between the tip (35) and the end (31).

As a result, it is possible to make a snick having a rounded bottom and a curved rim, as illustrated in FIG. 6.

Referring to FIG. 7, there is shown a fourth preferred embodiment of the rotary engraving tool (4) in accordance with the present invention.

In the fourth embodiment, the engraving tool (4) includes a cylindrical body (40) having a truncated cone (41), ending in a small-diameter section (42). The small-diameter section (42) and, optionally, the truncated cone (41) are provided with a tapered end (43) which terminates in a central projecting tip (47). This tool (4) is also formed with a pair of opposed main flutes (44) and a pair of opposed secondary flutes (48) all extending up to the central projecting tip (47).

The main flutes (44) are defined by respective chamfer faces (45), which form two cutting edges (46) at where they meet with both the tapered end (43) and the projecting tip (47), as in the case of the third embodiment.

However, the cutting edges (46) here are contoured to present a wide and substantially straight cutting part in the central projecting tip (47), with rounded upper corners on sides of the tip (47) and two curved transitions between the tip (47) and the end (43).

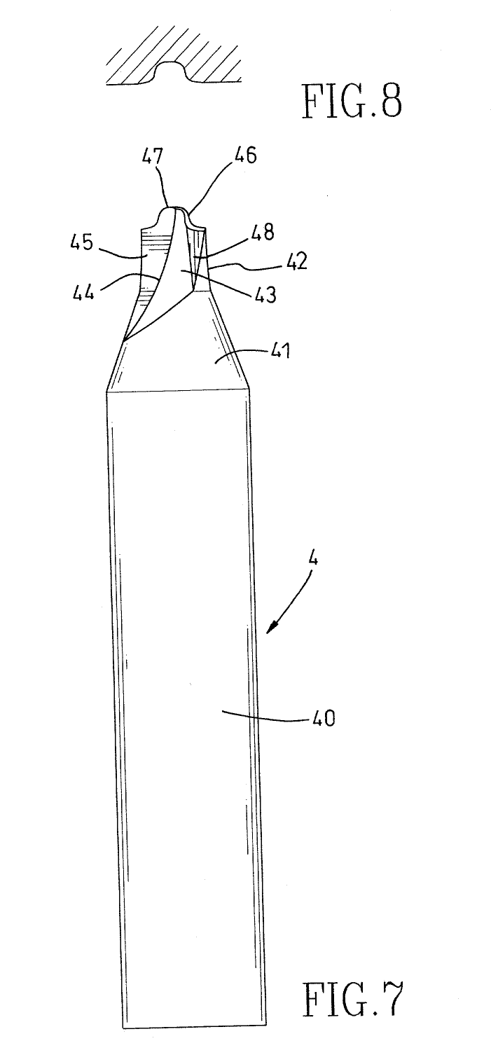

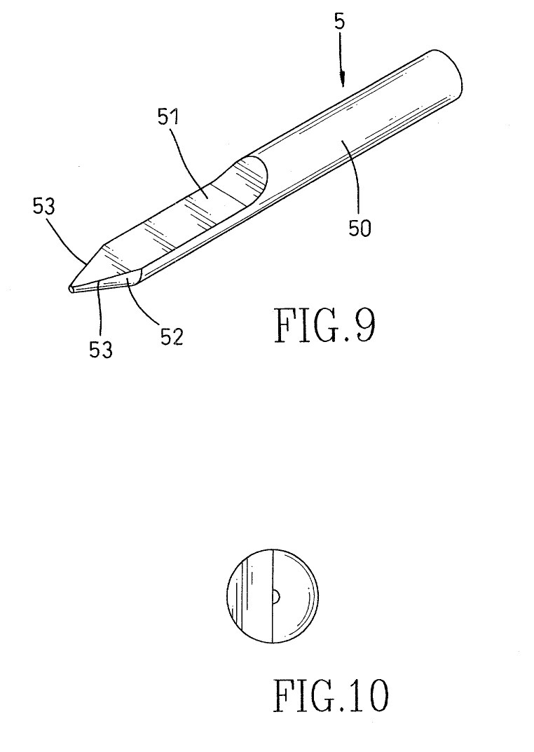

In this configuration, it is possible to make a snick which has a cross section shaped like a square or rectangle with rounded inner or upper corners and curved outer or lower corners, as best shown in FIG. 8.

From the above description, it is noted that the invention has the following advantages:

1. being excellent in making fine relief:

Because the two opposed cutting edges (14, 26, 34, 46) result in substantially equal and opposite cutting forces, the inventive cutting tool (1, 2, 3, 4) may remain straight while rotating and cutting and so a fine relief with smooth surfaces can be obtained.

2. being efficient in cutting:

Because the two opposed cutting edges (14, 26, 34, 46) work simultaneously, the efficiency for cutting is highly improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rotary engraving tool comprising a cylindrical body (10, 20, 30, 40) having a tapered end (11, 23, 31,43), said cylindrical body (10, 20, 30, 40) being formed with a pair of opposed main flutes (12, 24, 32, 44) defined at least partially by respective chamfer faces (13, 25, 33, 45), said chamfer faces (13, 25, 33, 45) extending to said tapered end (11,23,31,43) and forming two cutting edges (14,26,34,46) at where said chamfer faces (13, 25, 33, 45) meet with said tapered end (11, 23, 31, 43).

2. The rotary engraving tool as claimed in claim 1, wherein said cylindrical body (10, 20, 30, 40) is formed with a pair of opposed secondary flutes (15, 27, 36, 48) extending to said tapered end (11, 23, 31, 43) and arranged between said main flutes (12, 24, 32, 44).

3. The rotary engraving tool as claimed in claim 1, wherein said cylindrical body (20, 40) includes a truncated cone (21, 41) ending in a small-diameter section (22, 42), and wherein said small-diameter section (22, 42) is provided with said tapered end (23, 43).

4. The rotary engraving tool as claimed in claim 1, wherein said cutting edges (14) present a wide and substantially straight cutting part near an intersection thereof.

5. The rotary engraving tool as claimed in claim 1, wherein said cutting edges (26) present a rounded cutting part near an intersection thereof.

6. The rotary engraving tool as claimed in claim 1, wherein said tapered end (31, 43) terminates in a central projecting tip (35, 47), and wherein said main flutes (32, 44) extend up to said central projecting tip (35, 47).

7. The rotary engraving tool as claimed in claim 6, wherein said cutting edges (34) present a rounded cutting part in said central projecting tip (35).

8. The rotary engraving tool as claimed in claim 6, wherein said cutting edges (46) present a wide and substantially straight cutting part in said central projecting tip (47).
